(19) United States
(12) Patent Application Publication
(10) Pub. No.: US 2019/0213665 A1
(43) Pub. Date: Jul. 11, 2019

(54) SYSTEMS AND METHODS FOR BUILDING IMPULSE PRODUCT SHELVES IN ONLINE SHOPPING PLATFORMS

(71) Applicant: WM. WRIGLEY JR. COMPANY, Chicago, IL (US)

(72) Inventors: Mathew LIEW, Chicago, IL (US); Alexis MOODY, Chicago, IL (US); Larissa PITTENGER, Chicago, IL (US); Nikki STRATTON, Chicago, IL (US); JJ SCHMIDT, Chicago, IL (US); Chuck VAN HYNING, Chicago, IL (US)

(21) Appl. No.: 16/302,121

(22) PCT Filed: May 18, 2017
(86) PCT No.: PCT/US17/33238

§ 371 Date: Nov. 16, 2018

Related U.S. Application Data
(60) Provisional application No. 62/339,618, filed on May 20, 2016.

(51) Int. Cl. G06Q 30/06; G06Q 30/02

(52) U.S. Cl. CPC G06Q 30/0643; G06Q 30/0631; G06Q 30/0253

(57) ABSTRACT

Methods and systems for building impulse product shelves in online shopping platforms are disclosed. A user platform circuit and a user network circuit exchange product information with a merchant computing system over a network. The user platform circuit and user input and output devices generate a graphical user interface relating to the product information exchanged with the merchant computing system. A user impulse circuit and the user platform circuit identify available impulse products in the product information exchanged with the merchant computing system, and an impulse product shelf comprising at least one identified impulse product is constructed in the graphical user interface. The user platform circuit and the user input and output devices assemble purchase transaction requests, which are transmitted over the network.

### BACKGROUND

With rapid developments in computer networks and hardware as well as shipping and logistics, consumers are increasingly purchasing products online as opposed to brick-and-mortar stores. Correspondingly, consumer shopping behaviors are rapidly changing as well. Online shoppers can be highly focused in their shopping habits, using targeted searches for specific products and services. As such, online shopping platforms employ predictive algorithms and tuned search algorithms to quickly bring relevant products and ads to consumers' attention. In addition, with many consumers shopping online via mobile devices, laptops, and desktop computers with small screens, real estate for product displays and product information is scarce and valuable.

### SUMMARY

One embodiment relates to a non-transitory computer-readable media that stores a set of instructions which, when executed by a processor at a user computing device, performs operations. The operations include exchanging, through a user platform circuit and a user network circuit, product information with a merchant computing system over a network. The operations further include generating, through the user platform circuit and user input and output devices, a graphical user interface relating to the product information exchanged with the merchant computing system. The operations include identifying, through a user impulse circuit and the user platform circuit, available impulse products in the product information exchanged with the merchant computing system. The operations further include constructing, through the user impulse circuit, the user platform circuit, and the user input and output devices, an impulse product shelf comprising at least one identified impulse product in the graphical user interface. The operations include assembling, through the user platform circuit and the user input and output devices, purchase transaction requests. The operations further include transmitting, through the user platform circuit, purchase transaction requests over the network.

Another embodiment relates to a method of building impulse product shelves into online shopping platforms. The method includes exchanging, by a user platform circuit and a user network circuit, product information with a merchant computing system over a network. The method further includes generating, by the user platform circuit and user input and output devices, a graphical user interface relating to the product information exchanged with the merchant computing system. The method includes identifying, by a user impulse circuit and the user platform circuit, available impulse products in the product information exchanged with the merchant computing system. The method further includes constructing, by the user impulse circuit, the user platform circuit, and the user input and output devices, an impulse product shelf comprising at least one identified impulse product in the graphical user interface. The method includes assembling, by the user platform circuit and the user input and output devices, purchase transaction requests. The method further includes transmitting, by the user platform circuit, purchase transaction requests over the network.

Yet another embodiment relates to a user computing device. The device includes a user network circuit enabling the user computing device to exchange information over a network. The device further includes user input and output devices enabling a user to exchange information with the user computing device. The device includes a user platform circuit. The user platform circuit is configured to exchange product information with a merchant computing system over the network. The user platform circuit is further configured to cooperate with the user input and output devices to generate a graphical user interface relating to the product information exchanged with the merchant computing system. The user platform circuit is configured to cooperate with the user input and output devices to assemble purchase transaction requests. The user platform circuit is further configured to transmit purchase transaction requests over the network. The device further includes a user impulse circuit. The user impulse circuit is configured to cooperate with the user platform circuit to identify available impulse products in the product information exchanged with the merchant computing system. The user impulse circuit is further configured to cooperate with the user platform circuit and the user input and output devices to construct an impulse product shelf comprising at least one identified impulse product in the graphical user interface.

### BRIEF DESCRIPTION OF THE DRAWINGS

FIG. 1 is a block diagram illustrating a transaction system, according to an example arrangement.

FIG. 2A is a block diagram illustrating additional features of the system shown in FIG. 1, according to an example arrangement.

FIG. 2B is a block diagram illustrating additional features of the system shown in FIG. 1, according to an alternative example arrangement.

FIGS. 3A-3C and 4A-4B are example screens generated on a graphical user interface at a user computing device, according to example arrangements.

FIG. 5 is a flowchart of a method of building impulse product shelves into online shopping platforms, according to an example arrangement.

### DETAILED DESCRIPTION

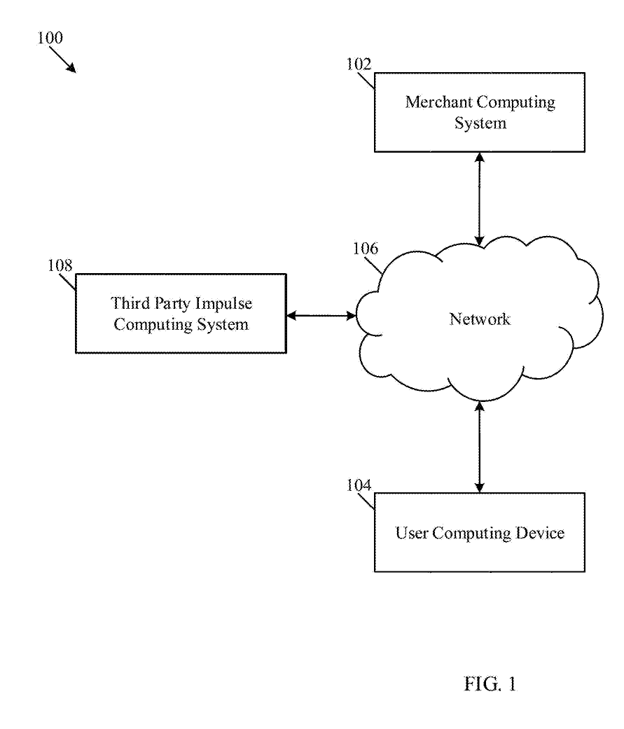

Referring to FIG. 1, a transaction system 100 constructs impulse product shelves in various online shopping environments. Impulse product shelves include product displays or menus that are presented to consumers at one or more times during a given shopping session. In various arrangements, impulse product shelves are populated with products that may not be related to the contents of the consumer's shopping cart or the consumer's shopping behavior. In some arrangements, impulse product shelves are populated with products that tend to be low-cost, easily appreciated, useful, or enjoyable. Hence, impulse product shelves may include low-barrier products that are more likely to be subject to “impulse” purchases. Further, impulse product shelves provide merchants with high margin add-on opportunities while providing consumers with convenient reminders of needed or desired items that may not have been the intended subject of a given shopping session. Example of impulse products include confections, chocolates, mints, gums, snacks, beverages, batteries, small tools, cosmetics, gift cards, and so on.

The system 100 includes a merchant computing system 102 and a user computing device 104, each of which may be communicatively coupled to a network 106. In some arrangements, the system 100 further includes a third party computing system 108.

The merchant computing system 102 is a computing system associated with one or more merchants of goods and/or services. The merchant computing system 102 provides or enables various online shopping platforms for consumers to shop for and purchase goods and/or services (e.g., websites, shopping software applications or “apps”, and so on). Such shopping platforms may be specific to one or more related commercial entities (e.g., a shopping website associated with a specific retailer or retailer group, such as www.target.com) or may be a broader shopping marketplace made up of a plurality of related or unrelated commercial entities (e.g., marketplace services provided by Amazon™, eBay™, Etsy™, and so on).

The user computing device 104 is a computing system that is used by one or more consumers. The user computing device 104 is configured to execute software applications (e.g., online shopping apps), access websites, generate graphical user interfaces, receive various inputs, generate various outputs, and so on. Examples of the user computing device 104 include laptops, desktop computers, remote or local servers (e.g., providing virtual or hosted desktops), smartphones, tablets, wearable computing devices such as eyewear and watches, and so on.

The network 106 enables components of the system 100 to communicate with each other (e.g., the merchant computing system 102 and the user computing device 104). The network 106 is a data exchange medium, which may include wireless networks (e.g., cellular networks, Bluetooth®, WiFi, LiFi, Zigbee®, etc.), wired networks (e.g., Ethernet, DSL, cable, fiber-based, etc.), or a combination thereof. In some arrangements, the network 106 includes the internet.

In operation, a consumer may use the user computing device 104 to access a shopping platform provided by the merchant computing system 102 over the network 106. The merchant computing system 102 may provide data over the network 106 to populate a visual representation of the shopping platform on the user computing device 104, and the consumer may engage in a shopping session. The consumer may navigate the shopping platform on the user computing device 104, searching for and perusing various products and services offered by the merchant or merchants associated with the merchant computing system 102. At various points during the shopping session, the consumer may identify and select products and services to be purchased through the shopping platform (e.g., adding items to an online “shopping cart”).

At one or more times before the consumer completes the shopping session, components of the system 100 construct and present an impulse product shelf to the consumer. In some arrangements, the merchant computing system 102 is configured to remotely construct the impulse product shelf and present the impulse product shelf on the user computing device 104 over the network 106. In other arrangements, the user computing device 104 is configured to construct and present the impulse product shelf to the consumer.

The impulse product shelf may be presented to the consumer at various times during the shopping session. In some arrangements, the impulse product shelf may be presented after the consumer initiates a checkout process, for example as part of a checkout screen. In some arrangements, the impulse product shelf may be presented during predetermined or random intervals throughout the shopping session. In some arrangements, the impulse product shelf may be presented during periods of downtime (e.g., as part of a loading screen) or consumer inactivity. In addition, in some arrangements, presentation of the impulse product shelf may be preceded by an unobtrusive invitation to view the impulse product shelf (e.g., a labeled button, banner, alert symbol, and so on).

The impulse product shelf may be constructed with various impulse products offered by the merchant or merchants associated with the merchant computing system 102. In some arrangements, the contents of the impulse product shelf are populated independently of the contents of the shopping behavior of the consumer (e.g., the consumer's product or service searches performed during the shopping session) or the contents of the consumer's shopping cart. In such arrangements, the impulse product shelf may be populated with products commonly considered as products subject to impulse purchases (e.g., confections, tissues, pens, etc.).

In various arrangements, upon being presented with the impulse product shelf, the consumer may select and add one or more presented impulse products therefrom, close the impulse product shelf, or ignore the impulse product shelf altogether. If the consumer selects one or more of the impulse products from the impulse product shelf, those products may be added to the consumer's list of items to be purchased (e.g., to a shopping cart), and the consumer may check out and complete a corresponding purchase transaction as normal.

In some arrangements, the user computing device 104 may present the impulse product shelf or a notification relating to the availability of an impulse product to a consumer independently of shopping sessions. In some such arrangements, the user computing device 104 may be configured to monitor the content that the consumer is viewing on the user computing device 104 and trigger an impulse shelf notification in response to some predetermined criteria. For example, the impulse shelf notification can be triggered if predetermined content (e.g., words, images, etc.) are being viewed on the user computing device 104. Such content may include types of impulse products, brands of impulse products, actual product names, or categories or concepts relating to certain impulse products (e.g., mentions of bad breath can trigger a notification for a breath freshening gum). The consumer may interact with the notification (e.g., clicking a popup notification) to initiate a shopping session at an online shopping platform with a corresponding impulse product available. In some arrangements, the online shopping platform may start the shopping session by adding the impulse product to a shopping cart automatically. In some arrangements, the online shopping platform may start the online shopping session by generating and presenting an impulse product shelf containing the impulse product.

The third party impulse computing system 108 is included in some arrangements of the system 100. The third party impulse computing system 108 is a computing system that may not be associated with the merchant computing system 102 or the user computing device 104, but enhances functionalities relating to impulse shelves on the user computing device 104. In various arrangements, the third party impulse computing system 108 may be associated with a software provider associated with software enabling the user impulse circuit discussed below. In some arrangements, the third party impulse computing system 108 is associated with a manufacturer or supplier of a given impulse product. In such arrangements, the third party impulse computing system 108 may be structured to communicate with the user computing device 104 and track individual user activity. In addition, the third party impulse computing system 108 may be structured to manage impulse product-based loyalty programs (e.g., discount-based, points-based, etc.) with respect to certain types, brands, etc. of various impulse products to incentivize use of impulse shelves. The third party impulse computing system 108 may also be used to communicate with the merchant computing system 102 and/or the user computing system 104 to effect discounts, credits, rebates, and gift purchases (e.g., transmitting payments to merchants, vouchers to consumers, etc.).

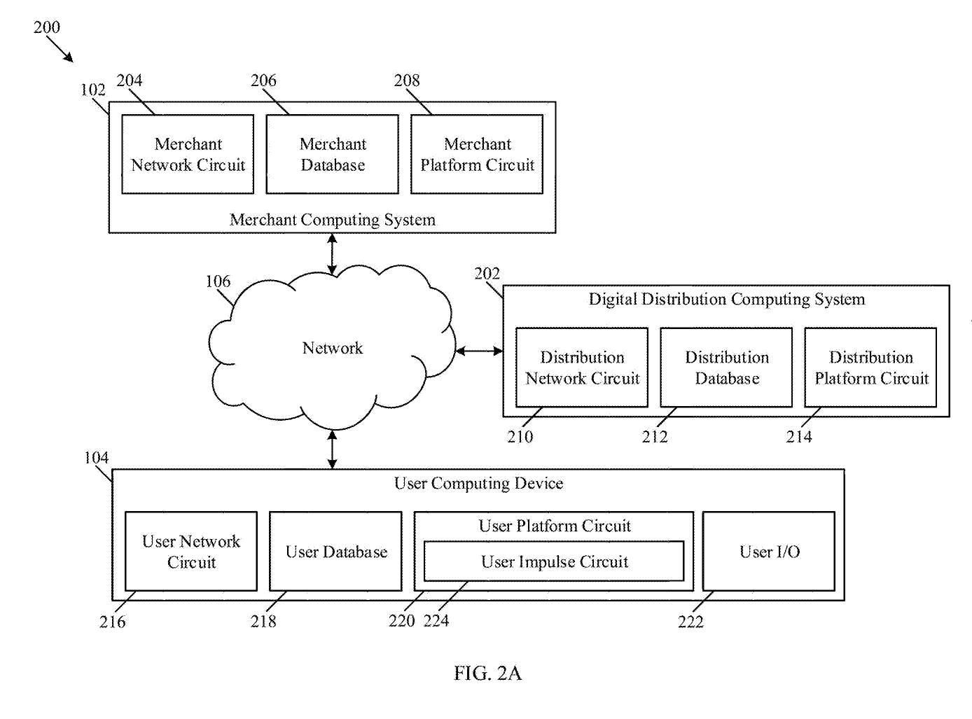

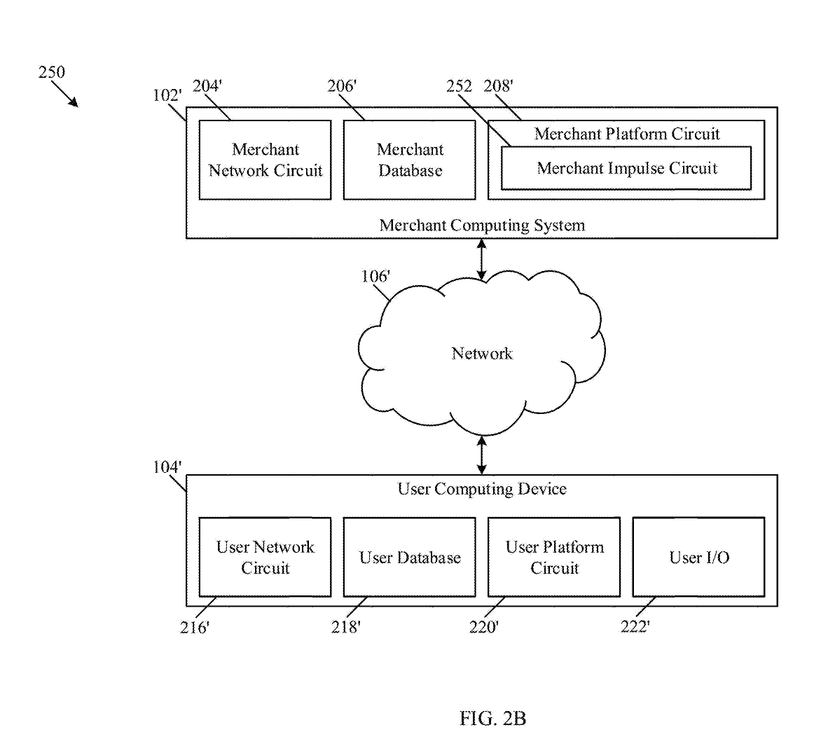

Referring now to FIG. 2A, a more detailed system 200 illustrating an example arrangement of the components of the system 100 is shown. The system 200 includes the merchant computing system 102, the user computing device 104, and a digital distribution computing system 202, each of which is communicatively coupled to the network 106.

In the system 200, the merchant computing system 102 includes a merchant network circuit 204, a merchant database 206, and a merchant platform circuit 208. As used herein, the term “circuit” may include hardware structured to execute the functions as described. For example, a given “circuit” may include one or more processors communicatively coupled to a memory. In some embodiments, each respective “circuit” may also include software for configuring the hardware to execute the functions described herein. With respect to the merchant network circuit 204, the merchant network circuit 204 is structured to enable the merchant computing system 102 to exchange data over the network 106.

The merchant database 206 allows the merchant computing system 102 to retrievably store data relating to an online shopping platform. The term “database” refers to data storage systems that may be used to support various operations discussed herein, and may include, for example, non-transient data storage mediums (e.g., local disc or flash-based hard drives, local network servers, and the like) or remote data storage facilities (e.g., cloud servers). The merchant database 206 may include information relating to the shopping platform of the merchant or merchants associated with the merchant computing system 102. For example, the merchant database 206 may include information relating to products and services to be offered through the shopping platform, including itemized product and service descriptions, inventory, consumer reviews, and so on. The merchant database 206 may further include information relating to consumers using the shopping platform, including personal consumer information (e.g., names, shipping information, billing information, and so on). In some arrangements, the merchant database 206 may also include various data files, images, and so on relating to shopping platforms in the form of websites. In addition, in some arrangements, the merchant database 206 may include shopping platform app installation software that may be downloaded and installed on the user computing device 104.

The merchant platform circuit 208 cooperates with the merchant network circuit 204 and the merchant database 206 to provide consumers with an online shopping platform. For example, the merchant platform circuit 208 may route information from the merchant database 206 to the network 106 via the merchant network circuit 204 to allow the user computing device 104 to generate a shopping website for a consumer or to enable the operation of an online shopping app.

The merchant platform circuit 208 may exchange information with the user computing device 104 throughout a given shopping session. For example, the merchant platform circuit 208 may receive product search queries from the user computing device 102, and the merchant platform circuit 208 may in turn run the product search queries in the merchant database 206 and return the results to the user computing device 104. The merchant platform circuit 208 may also receive consumer information (e.g., consumer names, shipping information, payment information, etc.) and order information (e.g., identified products and services, quantities, shipping preferences, etc.) and store such information in the merchant database 204. In addition, the merchant platform circuit 208 may assemble and transmit payment requests to financial institutions and/or payment card networks as appropriate. The merchant platform circuit 208 may be configured to perform various other functions relating to the enabling of the shopping platform on the merchant side as well.

The digital distribution computing system 202 provides a software distribution platform over the network 106. In some arrangements, the software distribution platform provides a software marketplace that offers copies of various software applications (e.g., software apps, browser plugins, etc.) and corresponding paid or free licenses. In such arrangements, software may be provided by and used by various users, including both business entities (e.g., the merchant or merchants associated with the merchant computing system 102) and individuals (e.g., consumers using the user computing device 104). Examples of such software marketplaces include the Apple Store™ and the Google Play™ store. In other arrangements, the digital distribution computing system 202 may be associated with individual or groups of entities with a comparatively limited offering of software (e.g., software generated by a given development company).

The digital distribution computing system 202 includes a distribution network circuit 210, a distribution database 212, and a distribution platform circuit 214. The distribution network circuit 210 allows the digital distribution computing system 202 to exchange information over the network 106.

The distribution database 212 stores various software applications to be made available over the software distribution platform, corresponding license information, and software distribution platform data (e.g., images, code, etc. for the software distribution platform itself). In some arrangements, the distribution database 212 includes consumer information, for example consumer account information (e.g., username and passwords), active license information (e.g., purchase and/or download histories), and so on.

The distribution platform circuit 214 cooperates with other components of the digital distribution computing system 202 to provide the software distribution platform to other computing systems over the network 106. The distribution platform circuit 214 may regulate other computing systems' access and use of the information in the distribution database 212, sign new consumers up for the software distribution platform, and track consumer activity and licenses.

The user computing device 104 includes a user network circuit 216, a user database 218, a user platform circuit 220, and user input and output devices (“I/O”) 222. The user network circuit 216 enables the user computing device 104 to exchange information over the network 106.

The user database 218 stores information relating to the operation of the user computing device 104, including the consumer's access to and use of the shopping platform of the merchant computing system 102. For example, an operating system, software applications, user settings, user preferences, and so on may be stored in the user database 218.

The user I/O 222 includes hardware and corresponding software that allows consumers to exchange information with the user computing device 104. Output devices of the user I/O 222 are configured to communicate information to consumers at the user computing device 104. Output devices of the user I/O 222 may convey information to consumers via sight (e.g., via displays, illuminated icons, lights, etc.), sound (e.g., via speakers), or touch (e.g., via vibration). In turn, input devices of the user I/O 222 are configured to provide the consumer with various ways to provide information to the user computing device 104. Example input devices include touchscreens, keyboards, pointing devices, microphones, styluses, buttons, cameras, and so on.

The user platform circuit 220 cooperates with other components of the user computing device 104 and the merchant computing system 102 to allow consumers to interact with the online shopping platform. In some arrangements, consumers may provide a uniform resource identifier (e.g., a uniform resource locator or web address) corresponding to the online shopping platform to an internet browser (e.g., Chrome™, Firefox™, Opera™, etc.). The internet browser may then access the merchant computing system 102, which may configure the user platform circuit 220 by providing the user computing device 104 with data to generate a graphical user interface corresponding to the online shopping platform and support consumer shopping sessions. In other arrangements, the user platform circuit 220 results from the installation of a shopping platform app (e.g., as downloaded and installed from the digital distribution computing system 202). The app may include graphical user interface data, and may further configure the user platform circuit 220 to retrieve shopping data from the merchant computing system 102 to support consumer shopping sessions. The user platform circuit 220 may also cooperate with the user I/O 222 to prepare and transmit payment transactions to financial institutions and/or card networks as appropriate.

The user impulse circuit 224 is configured to cooperate with various online shopping platforms to provide consumers with impulse product shelves. In various arrangements, the user impulse circuit 224 may be assembled in the user computing device 104 after a consumer downloads and installs a corresponding software app from the digital distribution computing system 202. In some arrangements, the app corresponding to the user impulse circuit 224 is separately downloaded and installed from an app corresponding to the user platform circuit 220. In other arrangements, software corresponding to the user impulse circuit 224 is included in the software corresponding to the user platform circuit 220.

In various arrangements, the user impulse circuit 224 may be configured to add or modify the functions of the user platform circuit 220 to provide impulse product shelves at one or more times during consumer shopping sessions. The user impulse circuit 224 may identify time intervals (e.g., after a predetermined period of time into a given shopping session has elapsed) or stages (e.g., when a consumer has chosen to view the contents of a shopping cart, or when a consumer has initiated a checkout process), and present to the consumer an alert relating to the availability of an impulse product shelf, or the impulse product shelf itself.

The user impulse circuit 224 may generate impulse product shelves via one or more background processes that may not be visible to consumers. For example, throughout the course of a shopping session, the user impulse circuit 224 may access and search the merchant database 206 over the network to identify candidates for an impulse product shelf. The user impulse circuit 224 may then incorporate a visual representation of the impulse product shelf containing impulse products offered by the merchant or merchants associated with the merchant computing system 102.

In operation according to one arrangement, a consumer uses the user I/O 222 to open an internet browser and accesses the software distribution platform of the digital distribution computing system 202 over the network 106. The consumer searches for, downloads, and installs an internet browser plugin (e.g., a Chrome™ extension), which assembles the user impulse circuit 224 in the user computing device 104. The consumer subsequently uses the internet browser to access the merchant computing system 102, which in turn assembles the user platform circuit 220 on the user computing device 104 and allows the consumer to use a corresponding online shopping platform. The user impulse circuit 224 recognizes the user platform circuit 220, and begins cooperating with the user platform circuit 220 to assemble an impulse product shelf using available items from the merchant database 206. After the consumer adds products to a shopping cart provided through the user platform circuit 220, the consumer opts to begin a checkout process to purchase the items in the shopping cart. The user impulse circuit 224 may then incorporate an impulse product shelf in a checkout screen provided by the user platform circuit 220, including an offering of impulse products available through the merchant computing system 102. The consumer may add any impulse products from the impulse product shelf as desired, and/or complete the checkout process to complete a purchase transaction.

In operation according to another arrangement, the user platform circuit 220 is assembled as a result of downloading and installing a corresponding software app from the software distribution platform. The user impulse circuit 224 may also be assembled as a result of downloading and installing another corresponding software app (i.e., instead of an internet browser plugin). As the consumer initiates a shopping session in the online shopping platform provided through the user platform circuit 220, the user impulse circuit 224 may recognize the consumer's use of the user platform circuit, and use the merchant database 206 to generate an impulse product shelf. Fifteen minutes into the shopping session, the user impulse circuit 224 provides the consumer with an alert (e.g., a button or toggle in the online shopping platform graphical user interface, a push notification, a popup, etc.) that an impulse product shelf is available. The consumer selects the alert, which causes the user impulse circuit 224 to present the impulse product shelf to the consumer on the user I/O 222. The consumer selects an impulse product, which is added to a shopping cart, and the consumer checks out and completes a corresponding payment transaction. As one of skill in the art would recognize, various alternative arrangements of these and other operations are possible within the context of the present disclosure.

Referring now to FIG. 2B, an alternative system 250 illustrating another example arrangement of the components of the system 100 is shown. The system 250 includes the merchant computing system 102′ and the user computing device 104′, each of which is communicatively coupled to the network 106′. As used herein, the use of a reference number and prime (′) (e.g., 102′, 104′) indicates another arrangement of the component assigned the corresponding reference number (e.g., 102, 104, respectively) as previously described. As such, for example, component 102′ may be configured in a similar manner as component 102, however 102′ may further or alternatively include certain differences as described herein.

In the system 250, the merchant computing system 102′ includes a merchant impulse circuit 252 associated with the merchant platform circuit 208′. The merchant impulse circuit 252 is configured to include impulse product shelves in the online shopping platform provided by the merchant computing system 102′. As such, when consumers using the user computing device 104′ accesses the merchant computing system 102′, the merchant impulse circuit 252 may incorporate impulse product shelves into the online shopping platform provided in the user platform circuit 220′.

For example, in operation, a consumer may use the user I/O 222′ to open a new internet browser window and enter a uniform resource locator corresponding to the merchant computing system 102′. The merchant platform circuit 208′ may provide the user computing device 104′ with data from the merchant database 206′ to assemble the user platform circuit 220′ on the user computing device 104′ (e.g., to load a webpage corresponding to the online shopping platform, or to enable a software app corresponding to the online shopping platform). The consumer may shop in the online shopping platform as normal, however the merchant impulse circuit 252 may also provide the consumer with alerts relating to the availability of impulse product shelves and/or instances of impulse product shelves (e.g., at predetermined or random intervals, at various stages of shopping sessions, etc.). In other words, impulse product shelves are assembled as part of the online shopping platform provided by the merchant platform circuit 208′ of the merchant computing system 102′ in the system 250. In contrast, in the system 200, impulse product shelves are assembled via the user platform circuit 220 of the user computing device 104′.

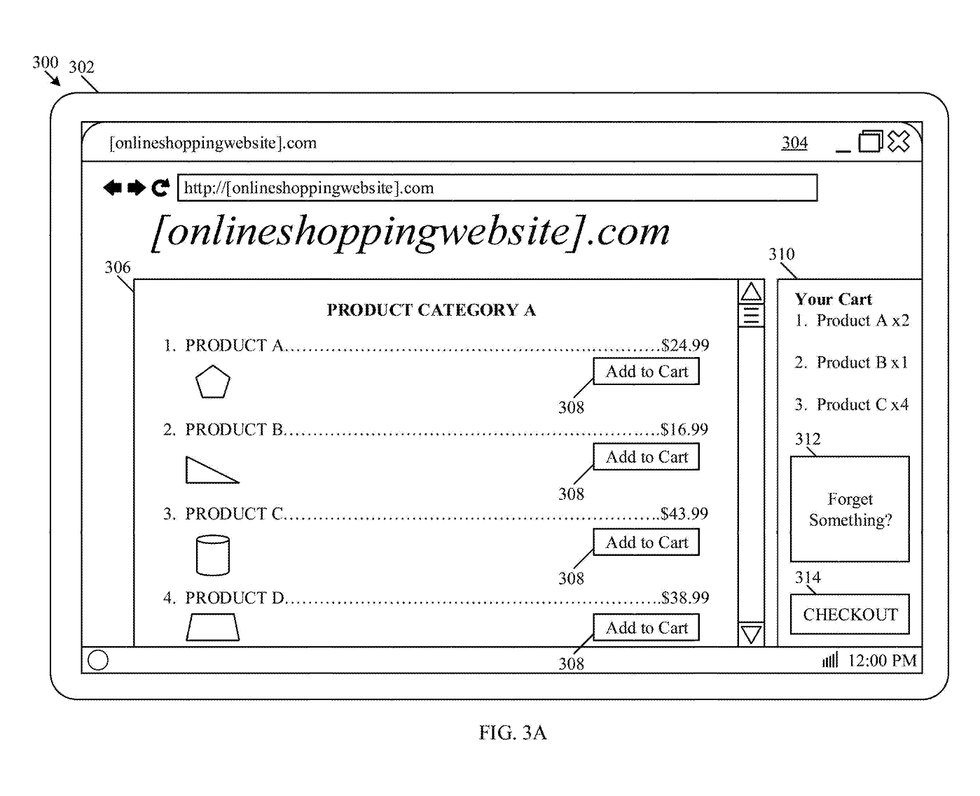

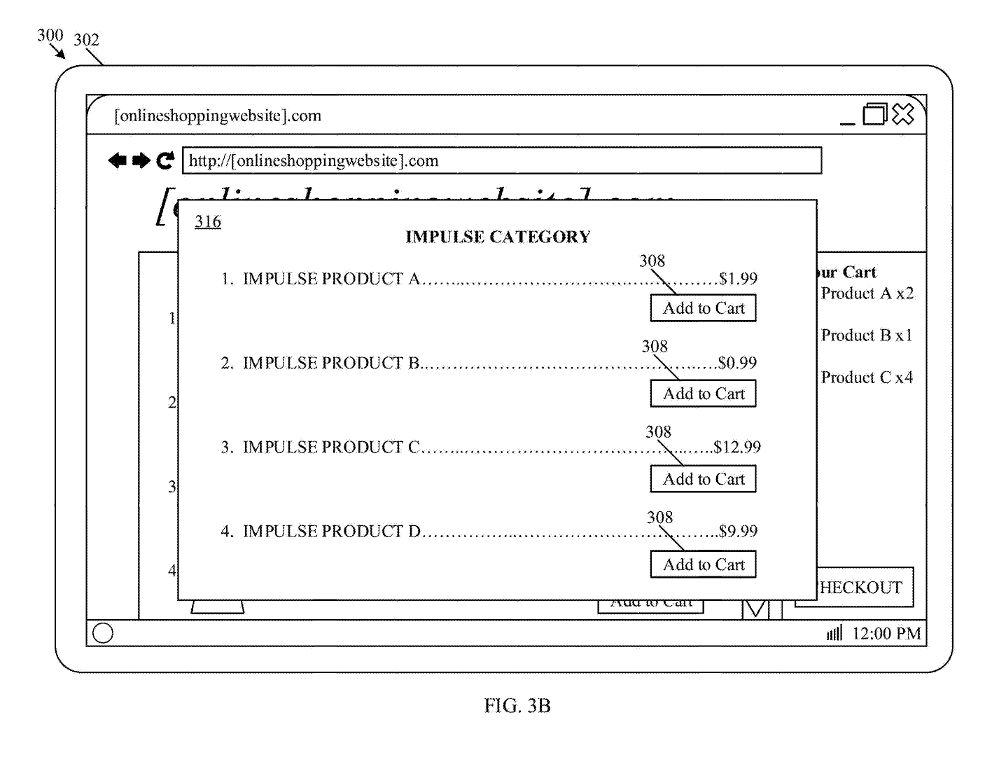

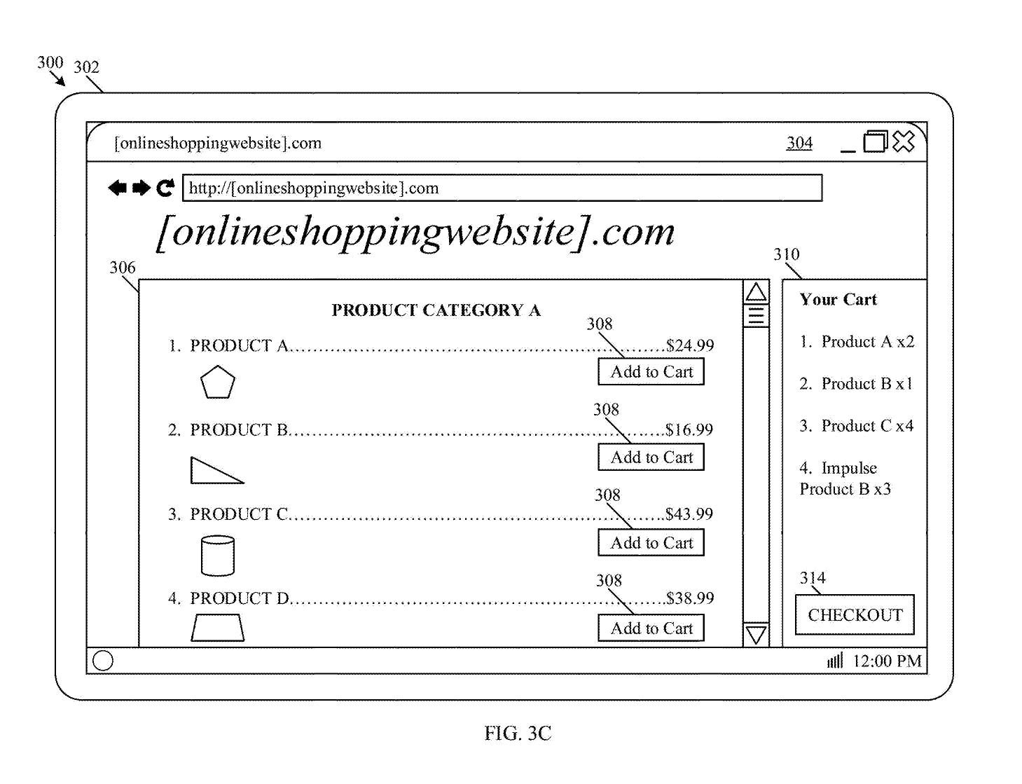

Referring to FIG. 3A, a shopping screen 300 of an online shopping platform is shown according to an example arrangement. The shopping screen 300 is shown as a graphical user interface on a display 302 (e.g., an arrangement of an output device of the user I/O 222). The graphical user interface is generated in an internet browser 304 after locating and retrieving information from a merchant computing system (e.g., the merchant computing system 102). The graphical user interface includes a shopping window 306 and a shopping cart 310. The shopping window 306 includes information relating to a plurality of products offered through the online shopping platform, including product names, images, and prices. The shopping window 306 further includes an “Add to Cart” button 308 for each product listed, with which a consumer may interact to add products to the shopping cart 310. The shopping cart 310 includes a summary of the consumer's selected products for purchase (e.g., product names and respective quantities).

In the arrangement shown, the shopping cart 310 further includes an alert 312 and a checkout button 314. The consumer may interact with the checkout button 314 to initiate a checkout process through which the consumer can prepare and complete a payment transaction to purchase the products in the shopping cart 310. The alert 312 is configured to draw the consumer's attention to the availability of an impulse product shelf. In various arrangements, the alert 312 may be generated by an impulse circuit (e.g., the user impulse circuit 224 or the merchant impulse circuit 252) periodically, at predetermined intervals, at random intervals, or at predetermined stages of a given shopping session. In some arrangements, the alert 312 is persistent throughout most or all of a given shopping session. The alert 312 may be presented to the consumer in an unobtrusive position in the graphical user interface, such that the alert 312 does not substantially interfere with the consumer's shopping session. In addition, the alert 312 may be configured to remind the consumer of potentially needed items that may not have been the intended targets of a given shopping session. The consumer may interact with the alert 312 to cause the graphical user interface to show an impulse product shelf.

Referring now to FIG. 3B, in response to a user interaction with the alert 312 of FIG. 3A, the graphical user interface on the display 302 has been updated to show a popup impulse product shelf 316. The popup impulse product shelf 316 is an overlay over the shopping window 306 and the shopping cart 310 and includes a plurality of products offered by the merchant associated with the online shopping platform. The plurality of products in the popup impulse product shelf 316 may be irrelevant to the contents of the shopping cart 310, and may be made up of available impulse products. The consumer may select one or more impulse products for purchase using respective “Add to Cart” buttons 308.

Referring now to FIG. 3C, in response to a user selection of an impulse product from the popup impulse product shelf 316, the shopping cart 310 has been updated to reflect the selected impulse product. In the arrangement shown, the alert 312 is now absent from the graphical user interface. The consumer may then select the checkout button 314 to complete a purchase transaction for the items in the shopping cart 310.

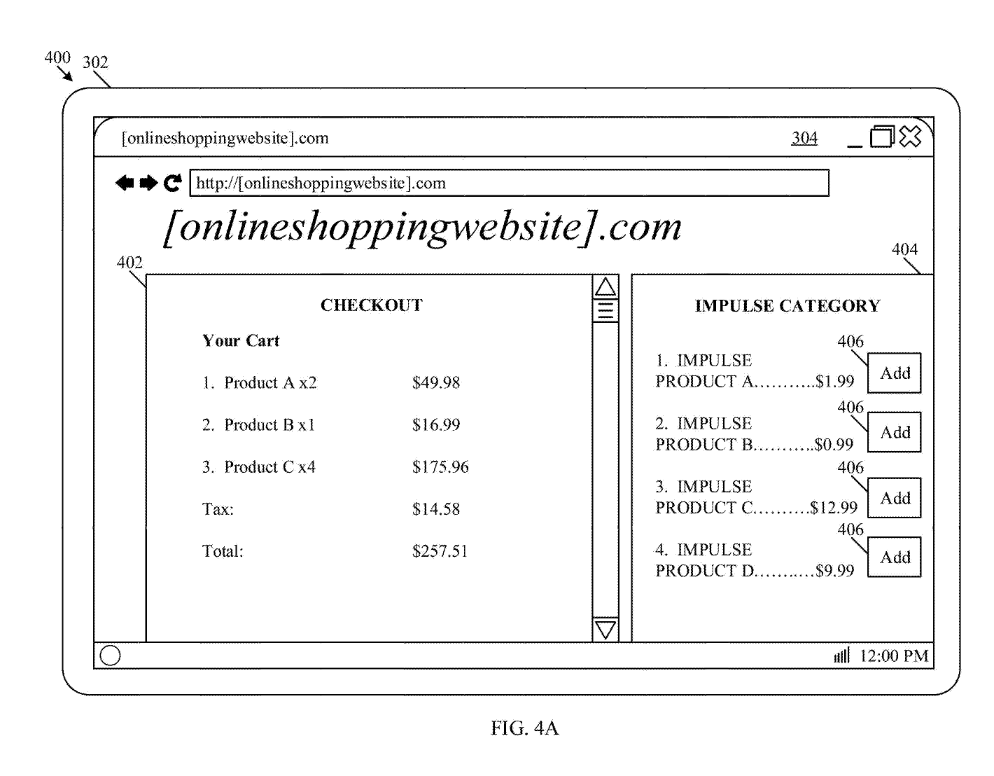

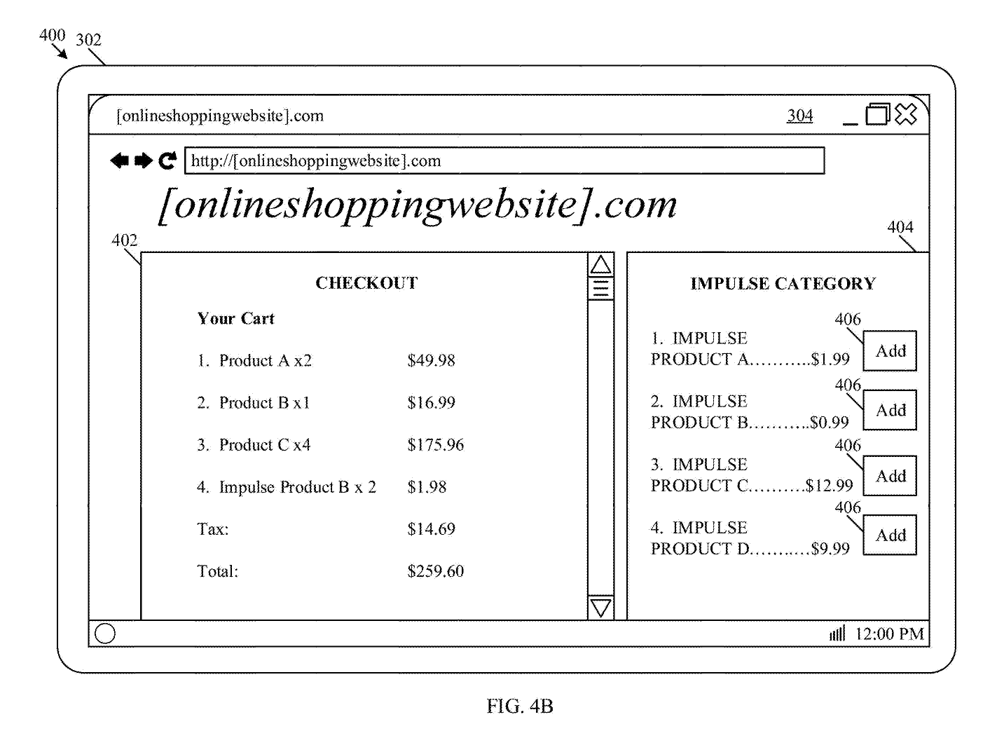

Referring now to FIG. 4A, an example arrangement of a checkout screen 400 of the online shopping platform is shown in the internet browser 304 on the display 302. The checkout screen 400 includes a checkout window 402 and a checkout impulse product shelf 404. The checkout window 402 includes information relating to the consumer's selected products for purchase, including product names, quantities, prices, tax, and so on. The checkout window 402 may further include information relating to shipping options, insurance, payment types, and so on. The checkout impulse product shelf 404 is shown alongside the checkout window 402 and is populated with impulse products, including impulse product names, prices, and corresponding “Add” buttons 406. Consumer interaction with a given “Add” button 406 will update the checkout window 402 to include the selected impulse product, including quantity and price, as shown in FIG. 4B.

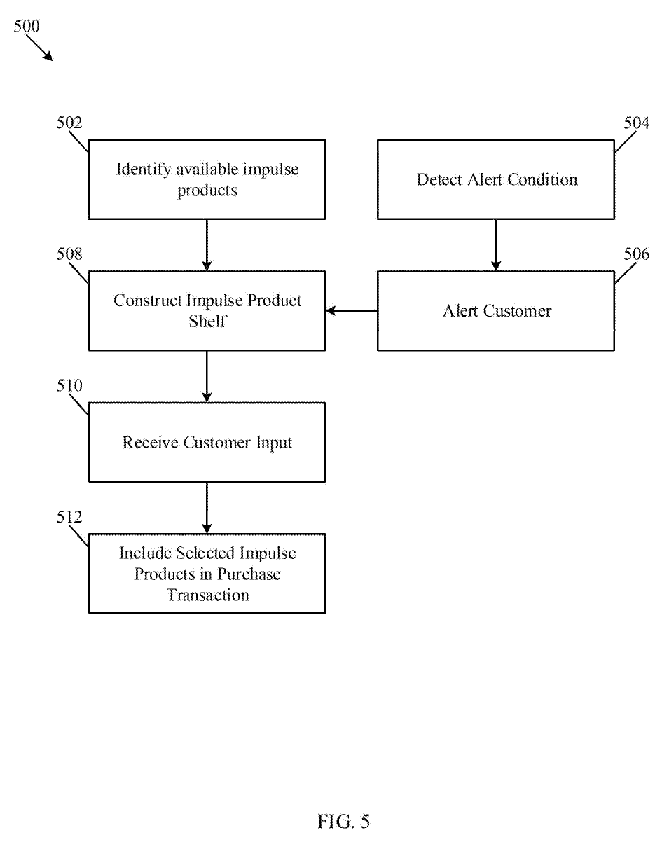

Referring now to FIG. 5, a method 500 of building impulse product shelves into online shopping platforms is shown. The method 500 is performed by processing and storage hardware at a computing system (e.g., merchant computing system 102 or user computing system 104), as executed by one or more circuits configured to perform the functions described below.

At 502, available impulse products in an online shopping platform are identified. Available impulse products include products offered by a merchant or merchants associated with a merchant computing system (e.g., the merchant computing system 102) that provides an online shopping platform. In some arrangements, a user impulse circuit (e.g., the user impulse circuit 224) at a user computing device (e.g., the user computing device 104) identifies available impulse products in a merchant database (e.g., the merchant database 206) at the merchant computing system. In other arrangements, a merchant impulse circuit (e.g., the merchant impulse circuit 252) identifies available impulse products in the merchant database.

In some arrangements, at 504, an alert condition is detected. The alert condition may be based on time (e.g., after a predetermined or random amount of time has elapsed), consumer activity in the online shopping platform (e.g., after conducting a minimum searching for a minimum number of products, after initiating a checkout process, and so on), among other conditions. For example, the alert condition may include idle periods where the consumer has not actively been using the online shopping platform for a threshold period of time, or periods of downtime where the online shopping platform is loading or otherwise paused or processing (e.g., returning search results, refreshing a page, etc.). The alert condition may be detected by the user impulse circuit or the merchant impulse circuit.

In arrangements where the alert condition is detected, at 506, the consumer is alerted. The consumer may be alerted through any output device of the user computing device (e.g., the user I/O 222, the alert 312, etc.). In various arrangements, the user impulse circuit or the merchant impulse circuit may cause an output device on the user computing device to generate the alert to draw the consumer's attention to the availability of an impulse product shelf. The alert may be generated in an unobtrusive way, such that the alert does not substantially interfere with the consumer's shopping session. In some arrangements, the alert may be presented as an instance of an impulse product shelf.

At 508, an impulse product shelf is constructed. The impulse product shelf is constructed on an output device at the user computing device. In some arrangements, the impulse product shelf may be integrated among other product displays or windows (e.g., as shown in FIGS. 4A and 4B). In other arrangements, the impulse product shelf may be presented as a popup window. In arrangements where an interactive alert (e.g., the alert 312) is presented to the consumer (e.g., at 506), the impulse product shelf may be presented in response to a user interaction with the alert. The consumer impulse circuit or the merchant impulse circuit may construct the impulse product shelf on the consumer output device.

At 510, consumer input is received. The consumer may use one or more input devices at the user computing device to select one or more impulse products in the impulse product shelf. The resulting consumer input corresponding to the consumer's desired impulse products may be received at the consumer impulse circuit or the merchant impulse circuit.

At 512, selected impulse products are included in a purchase transaction. In some arrangements, the user impulse circuit cooperates with the user platform circuit to assemble and transmit a payment transaction request to purchase the consumer's desired goods, including the consumer's selected impulse products. In other arrangements, the merchant impulse circuit cooperates with the merchant platform circuit 208 to assemble and transmit the payment transaction request. The payment transaction request is transmitted to a financial institution and/or a payment card network as appropriate, where the request may be approved and the consumer's desired products may be purchased.

The above arrangements have been described with respect to referenced drawings. The drawings indicate certain details of specific arrangements that implement example systems, methods and programs. As such, details of these drawings should not be considered as necessarily imposing limitations on the disclosure generally.

As used in this disclosure, the term “circuit” may include hardware structured to perform the functions described above. In some arrangements, a given “circuit” may include machine-readable data storage media that configures related hardware to execute those functions. The circuit may be associated with various devices including, but not limited to, processors, network-enabling devices, peripheral devices, I/O devices, etc. In some arrangements, a given circuit may embodied as analog circuits, electronic circuits, hybrid circuits, and any other type of “circuit” as commonly understood in the relevant art.

As indicated above, “circuits” may include at least one processor in communication with a memory. As such, a “circuit” may include a processor executing instructions stored in a memory, and further, a given processor may be a part of two or more “circuits”. In such arrangements, a processor perform operations independently or in conjunction with other co-processors. Processors may take the form of a single or multi-core processors, and may be locally or remotely disposed with respect to other features of a given circuit. In turn, each memory device of a given circuit may include non-transient volatile or non-volatile storage media (e.g., RAM, ROM, flash, disc-based, magnetic based, etc. media, or combinations thereof).

While drawings provided and discussed herein may indicate example orders and content of method steps, it should be understood that the order of these methods may vary across various arrangement of the present disclosure. Beyond the order of these method stops, certain steps may occur concurrently, in combination, sequentially, or in parallel as circumstances may warrant. As such, all of these variations are to be understood as falling within the scope of the present disclosure and captured within the claims provided.

What is claimed is:

1. A non-transitory computer-readable media that stores a set of instructions which, when executed by a processor at a user computing device, performs operations, the operations comprising:
exchange, through a user platform circuit and a user network circuit, product information with a merchant computing system over a network;
generate, through the user platform circuit and user input and output devices, a graphical user interface relating to the product information exchanged with the merchant computing system;
identify, through a user impulse circuit and the user platform circuit, available impulse products in the product information exchanged with the merchant computing system;
construct, through the user impulse circuit, the user platform circuit, and the user input and output devices, an impulse product shelf comprising at least one identified impulse product in the graphical user interface;
assemble, through the user platform circuit and the user input and output devices, purchase transaction requests; and
transmit, through the user platform circuit, purchase transaction requests over the network.

2. The media of claim 1, wherein the user platform circuit is constructed through an internet browser.

3. The media of claim 2, wherein the user impulse circuit is constructed through an internet browser plugin.

4. The media of claim 1, wherein the user platform circuit is constructed through a first software app.

5. The media of claim 4, wherein the user impulse circuit is constructed through a second software app.

6. The media of claim 1, further comprising detect, through the user impulse circuit, an alert condition before constructing the impulse product shelf.

7. The media of claim 6, wherein the alert condition is based on a predetermined length of time of a user shopping session.

8. The media of claim 6, wherein the alert condition is based on a predetermined length of user idle time.

9. The media of claim 6, wherein the alert condition is based on a user initiating a checkout process.

10. The media of claim 6, wherein the alert condition is based on downtime.

11. The media of claim 6, further comprising generate, through the user impulse circuit and the user input and output devices, an alert after the alert condition is detected and before the impulse product shelf is constructed.

12. The media of claim 11, wherein the alert includes a reminder.

13. A method of building impulse product shelves into online shopping platforms, the method comprising:
exchanging, by a user platform circuit and a user network circuit, product information with a merchant computing system over a network;
generating, by the user platform circuit and user input and output devices, a graphical user interface relating to the product information exchanged with the merchant computing system;
identifying, by a user impulse circuit and the user platform circuit, available impulse products in the product information exchanged with the merchant computing system;
constructing, by the user impulse circuit, the user platform circuit, and the user input and output devices, an impulse product shelf comprising at least one identified impulse product in the graphical user interface;
assembling, by the user platform circuit and the user input and output devices, purchase transaction requests; and
transmitting, by the user platform circuit, purchase transaction requests over the network.

14. The method of claim 13, further comprising detecting, by the user impulse circuit, an alert condition before constructing the impulse product shelf.

15. The method of claim 14, further comprising generating, by the user impulse circuit and the user input and output devices, an alert after the alert condition is detected and before the impulse product shelf is constructed.

16. A user computing device comprising:
a user network circuit enabling the user computing device to exchange information over a network;
user input and output devices enabling a user to exchange information with the user computing device;
a user platform circuit configured to:
exchange product information with a merchant computing system over the network;
cooperate with the user input and output devices to generate a graphical user interface relating to the product information exchanged with the merchant computing system;
cooperate with the user input and output devices to assemble purchase transaction requests; and
transmit purchase transaction requests over the network; and
a user impulse circuit configured to:
cooperate with the user platform circuit to identify available impulse products in the product information exchanged with the merchant computing system;
cooperate with the user platform circuit and the user input and output devices to construct an impulse product shelf comprising at least one identified impulse product in the graphical user interface.

17. The user computing device of claim 16, wherein the user platform circuit is constructed through an internet browser.

18. The user computing device of claim 17, wherein the user impulse circuit is constructed through an internet browser plugin.

19. The user computing device of claim 16, wherein the user platform circuit is constructed through a first software app.

20. The user computing device of claim 19, wherein the user impulse circuit is constructed through a second software app.
